(19) United States
(12) Patent Application Publication
(10) Pub. No.: US 2019/0126558 A1
(43) Pub. Date: May 2, 2019

(54) METHOD AND ASSEMBLY FOR GENERATING CONTROL DATA FOR THE MANUFACTURE OF A THREE-DIMENSIONAL OBJECT BY MEANS OF AN ADDITIVE MANUFACTURING METHOD

(71) Applicant: EOS GmbH Electro Optical Systems, Krailling (DE)

(72) Inventors: Christian Waizenegger, Krailling (DE); Peter Hein, Krailling (DE); Karl Wygant, Houston, TX (US); Werner Bosen, Houston, TX (US)

(73) Assignee: EOS GmbH Electro Optical Systems, Krailling (DE)

(21) Appl. No.: 15/801,932

(22) Filed: Nov. 2, 2017

(51) Int. Cl. B29C 64/393; B33Y 10/00; B33Y 50/02; B33Y 30/00; B29C 64/106; B29C 64/205

(52) U.S. Cl. CPC B29C 64/393; B33Y 10/00; B29C 64/205; B33Y 30/00; B29C 64/106; B33Y 50/02

(57) ABSTRACT

A method of generating control data for a manufacture of a three-dimensional object comprises the following steps: identifying surface data in a computer-based model of said object that correspond to a surface of the object, which is destined to get into contact with the fluid, determining the flow path adjacent a portion of said surface in said computer-based model, modifying said computer-based model such that support structure data are added to the model, said data specifying a support structure designed to be in contact with said portion of said at least one surface during the manufacture of said object, wherein said support structure data are added to the model such that at least one contact region between the support structure and said portion will essentially extend in parallel to the flow path adjacent said portion, preferably deriving control data for the manufacture of the object from the modified model.

### TECHNICAL FIELD OF THE INVENTION

The present invention is directed to a method of generating control data for a manufacture of a three-dimensional object by means of an additive manufacturing method. In particular, said manufactured three-dimensional object is destined to be used in a flow path of a fluid flowing in a designated way around or through said object.

### BACKGROUND OF THE INVENTION

In general, an additive manufacturing method is a method of generating objects by adding material. In some cases the building material may be a liquid such as in stereolithography, in other cases the building material will be in powder form such as in selective laser sintering or selective laser melting. Usually the objects are generated layer-wise in a sequential process with each layer corresponding to a cross-section of the object to be generated.

In particular when using a liquid building material, it is necessary to have supports for the object in order to avoid a deformation or movement of the parts during the manufacturing process. However, also in powder-based methods supports are used for making it easier to remove the finished object from the underlying building platform or for compensating stress that occurs during the manufacturing process within the object. For example, US 2010/0042241 A1 describes a method of creating modelling data for a structure to be created by a layered modelling apparatus, wherein support member data are generated taking into consideration an amount of change that will occur during the manufacturing, which amount of change is caused by drying, polymerization or sintering. Whereas US 2010/0042241 A1 describes support structures between a building platform and the object to be built during the manufacturing process, WO 2014/006192 A1 describes in addition non-vertical support structures that may be located e.g., within an internal cavity of the object.

The above-mentioned support structures either may remain at the finished object, in cases where this does not lead to any problems, or may be removed from the finished object. In the latter case, however, after the support structures have been removed, almost always there will remain small support structure residuals on the surface of the produced part. Depending on the surface quality requirements, such residuals need to be removed by post-processing (e.g., milling). This is particularly the case, when a surface region is destined to be located in a flow path of a fluid flowing over this surface, as such small residuals will negatively impair the behavior of the fluid.

Unfortunately, there may exist situations, in which a post-processing does not lead to a sufficient surface quality for a surface to be located within the flow path of a fluid due to deficient process characteristics. In particular, when the fluid flows through a channel through the object, after the removal of the internal support structures it may not be possible to adequately treat the surface within the channel as it is difficult to access.

### SUMMARY OF THE INVENTION

In view of the above problems it is an object of the invention to provide a method and an assembly for generating control data for the manufacture of a three-dimensional object by means of an additive manufacturing method able to lead to improved flow characteristics of a fluid flowing in a designated way around or through the object to be manufactured.

According to the invention a method of generating control data for a manufacture of a three-dimensional object by means of a layer-wise solidification of a building material (preferably using electromagnetic radiation or particle radiation) is provided, wherein said manufactured three-dimensional object is destined to be used in a flow path of a fluid flowing in a designated way around or through said object. In particular, said method comprises the following steps:

identifying surface data in a three-dimensional computer-based model of said three-dimensional object, said surface data corresponding to at least one surface of the manufactured three-dimensional object, which at least one surface is destined to get into contact with the fluid,

determining the flow path adjacent a portion of said at least one surface in said computer-based model,

modifying said three-dimensional computer-based model thus generating a modified computer-based model such that support structure data are added to the computer-based model, said support structure data specifying a support structure designed to be in contact with said portion of said at least one surface during the manufacture of said three-dimensional object,

wherein said support structure data are added to the computer-based model such that at least one contact region between the support structure and said portion of said at least one surface will essentially extend in parallel to the flow path adjacent said portion of said at least one surface and/or such that positions of a plurality of contact regions between a plurality of support structures and said portion of said at least one surface will essentially extend in parallel to the flow path adjacent said portion of said at least one surface and

(preferably) deriving control data for the manufacture of the three-dimensional object from the modified computer-based model.

In the above method, the control data for a manufacture of a three-dimensional object include and/or represent the geometric information about the shape of the object to be manufactured and geometric information about support structures at a surface of the object that comes into contact with a fluid. Of course, control data for the manufacturing may include also other information about the manufacturing process. The above method, however, refers in particular to the subset of the control data describing geometrically the object and some of the support structures.

When applying the above method, a support structure is added to a surface such that the contact region between said support structure and said surface extends essentially in parallel to the flow path at the surface. Thereby, the flow characteristics after a removal of the support structure are influenced only to a minimum extent, even if support structure residuals remaining on the surface were in contact with the fluid.

Furthermore, in the case of a plurality of support structures at a portion of a surface, according to the invention the positions of the respective plurality of contact regions between the support structures and the portion essentially will extend in parallel to the flow path adjacent said portion. This feature too will lead to a situation in which the flow characteristics are influenced only to a minimum extent by the residuals.

The invention is also applicable to a situation, in which the flow path of a fluid is different for different portions of the surface coming into contact with the fluid. Of course, the flow path may also depend on the velocity and type of the fluid. However, when an object to be used in the flow path of a fluid is designed, usually the behaviour of such object is simulated already at the design stage using specific information about the intended fluid flow. From such simulations, which are state of the art, information about the flow path of the fluid is available and can be used for implementing the inventive method.

The method according to the invention leads to an effect even when applied only to a portion of a surface that will come into contact with a fluid, meaning when applied only to a part of the surface area coming into contact with a fluid. However, it is also possible that support structures are added in an inventive way to the whole surface potentially coming into contact with a fluid.

According to the invention, as soon as a support structure is added to a surface that will be in the flow path of a fluid, it is advantageous to design said support structure in accordance with the above-described inventive method. The specific locations where support structures have to be added are known to the skilled person from simulation or experience.

Preferably, said support structure data define a support structure that has a longitudinal shape such that in a direction in parallel to the flow path it is longer than in any other direction not in parallel to the flow path.

When a support structure has a longitudinal shape extending in parallel to the flow path (which means that the support structure is orientated along the flow path), the flow characteristics are impaired only to a minimum extent, even when the support structure remains in the flow path (is not removed).

The invention is particularly applicable to a case, in which said at least one surface is located in a channel through said three-dimensional object. The reason for this is that in a channel through an object it is particularly difficult to remove residuals thoroughly.

Preferably, said support structure data are added in such a way to the computer-based model that, when a vertical direction is defined as a direction perpendicular to the plane in which the layers extend during the layer-wise manufacturing, at least a portion of the contact region is located at a lateral wall of the channel. This may serve to laterally stabilize the three-dimensional object during manufacture.

Preferably, said support structure data are added in such a way to the computer-based model that once the three-dimensional object has been manufactured in said contact region said support structure will provide a flow resistance that is smaller in the designated flow direction than in a direction angular thereto.

A support structure will almost always have differing resistances to a flow depending on its orientation with respect to a flow. According to this preferred implementation of the invention, the direction of the flow is taken into consideration in order to minimize the flow resistance. Here, the term “angular” refers to a direction which is at an angle to the flow direction that differs from zero degrees (for example, a direction opposite to the flow direction, which would correspond to an angle of 180°, or a direction perpendicular to the flow direction).

Preferably, said support structure data are added in such a way to the computer-based model that once the three-dimensional object has been manufactured said support structure will provide a flow resistance that is smaller in the designated flow direction than in a direction angular thereto. Accordingly, as not only a contact region but a whole support structure is oriented such that the flow resistance will be at minimum, even when the whole support structure remains at the object to be manufactured, the flow characteristics will be affected only to a minimum extent.

Preferably, said support structure data define said support structure to comprise a main support structure part and a contact support structure part, said contact support structure part being located adjacent said portion of said at least one surface, wherein said contact support structure part is essentially V-shaped, U-shaped or Π-shaped in a cross-section, preferably in a cross-section perpendicular to said flow path. With the support structure at the contact region having the specified shape, it is easier to remove the support structure, as the contact region becomes very small.

Preferably, said support structure data are added in such a way to the computer-based model that, when a vertical direction is defined as a direction perpendicular to the plane in which the layers extend during the layer-wise manufacturing, said support structure once manufactured consists of a multitude of essentially vertical portions, at least two of which are preferably interconnected laterally by at least one interconnection structure.

Accordingly, mechanical strength of a support structure is achieved with a minimum number of contact regions between the support structure and the surface.

Preferably, in the support structure having a multitude of essentially vertical portions (particularly referring to the orientation of the three dimensional object during manufacture), at least two of which are preferably interconnected laterally by at least one interconnection structure, said at least one interconnection structure does not reach vertically to said portion of said at least one surface. Such lateral interconnection structure is particularly suitable for instance in such cases in which a comparatively wide support structure needs to be realized in order to give sufficient lateral support. It also helps to add additional stability to the support structure in the vertical direction as it may serve to transfer essentially vertical forces from one vertical portion onto the other, thereby helping to distribute such vertical forces more equally.

Preferably, in the support structure once manufactured said at least one interconnection has its largest vertical extensions at or near the interfaces to the vertical portions that are interconnected. Even more preferably, in the support structure once manufactured said at least one interconnection has an essentially H-shaped or U-shaped cross-section in a plane perpendicular to said vertical portions. All these measures may serve to direct the forces which the support structure has to withhold into the vertical portions which can be realized to bear the highest loads.

An inventive method of manufacturing a three-dimensional object by means of a layer-wise solidification of a building material (preferably using electromagnetic radiation or particle radiation), wherein said manufactured three-dimensional object is destined to be used in the flow path of a fluid flowing in a designated way around or through said object, comprises the following steps:

generating control data for a manufacture of a three-dimensional object by means of a layer-wise solidification of a building material by using an inventive method for generating control data,

manufacturing said three-dimensional object on the basis of the control data by means of a layer-wise solidification of a building material.

When manufacturing objects on the basis of the control data provided by the inventive method, objects can be obtained that will show superior flow characteristics when used in the flow path of a fluid. For example, by the invention it is possible to obtain objects, in which an impeller is located in an internal channel through the object.

It should be mentioned that preferably said support structure is removed after the manufacture of said three-dimensional object in order to minimize flow resistance. When doing so, preferably after the removal of said support structure residuals of said support structure in said contact region are removed by means of a polishing treatment, said polishing treatment preferably including one of a milling step, an extrude honing step, a micro machining (MMP) step, an electrical discharge machining (EDM) step and a slide grinding (in particular a vibratory finishing) step

An inventive control data generating assembly for generating control data for a manufacture of a three-dimensional object by means of a layer-wise solidification of a building material (preferably using electromagnetic radiation or particle radiation), wherein said manufactured three-dimensional object is destined to be used in a flow path of a fluid flowing in a designated way around or through said object, comprises the following:

an identification unit engineered to identify surface data in a three-dimensional computer-based model of said three-dimensional object, said surface data corresponding to at least one surface of the manufactured three-dimensional object, which at least one surface is destined to get into contact with the fluid,

a determination unit for determining the flow path adjacent a portion of said at least one surface

a modification unit which in operation modifies said three-dimensional computer-based model thus generating a modified computer-based model such that support structure data are added to the computer-based model, said support structure data specifying a support structure designed to be in contact with said portion of said at least one surface during the manufacture of said three-dimensional object,

wherein said support structure data are added to the computer-based model such that at least one contact region between the support structure and said portion of said at least one surface will essentially extend in parallel to the flow path adjacent said portion of said at least one surface and/or such that positions of a plurality of contact regions between a plurality of support structures and said portion of said at least one surface will essentially extend in parallel to the flow path adjacent said portion of said at least one surface and

(preferably) a derivement unit which in operation derives control data for the manufacture of the three-dimensional object from the modified computer-based model.

The control data generating assembly e.g. may be part of a system for creating a computer-based 3D-model of an object to be manufactured by additive manufacturing. However, the assembly may also be a stand-alone computer or may even be integrated into an additive manufacturing apparatus. Here, the determination unit either may calculate by itself flow path data or may receive flow path data from a simulation program dedicated specifically to such calculations and known in the art.

An inventive apparatus for the manufacture of a three-dimensional object by means of a layer-wise solidification of a building material, wherein said manufactured three-dimensional object is destined to be used in the flow path of a fluid flowing in a designated way around or through said object, comprises an inventive control data generating assembly and/or a data interface thereto.

As the knowledge about the specifics of an additive manufacturing apparatus is not always present to a CAD designer being skilled in the specific design and application requirements for an object, a control data generating assembly preferably is located close to the additive manufacturing apparatus, either by being incorporated in the additive manufacturing apparatus or by being connected thereto via a data interface.

An inventive computer program comprises a sequence of instructions that enables a control data generating assembly to carry out an inventive method of generating control data and/or an apparatus for the manufacture of a three-dimensional object to carry out a method of manufacturing a three-dimensional object by means of a layer-wise solidification of a building material, when such sequence of instructions is carried out in the control data generating assembly and/or the apparatus for the manufacture of a three-dimensional object.

Though it is possible that all units of the control data generating assembly or at least a part thereof are implemented by hardware only, preferably, some, preferably all those units can be implemented by software.

Further developments according to the invention are described in the dependent claims. Here, features from the dependent claims and from the description related to the inventive methods may also refer to the inventive devices or vice versa, if there is no explicit statement that features refer only to a method and a device, respectively.

### BRIEF DESCRIPTION OF THE DRAWINGS

FIG. 1 shows a schematic representation of a laser sintering device as example for an additive manufacturing device.

FIG. 2 shows a vertical cut through an object to be manufactured by an additive manufacturing device, which object has a channel running therethrough.

FIG. 3 shows a view onto the right face of the object illustrated in FIG. 2.

FIG. 4 shows an oblique view onto the vertical cut of FIG. 2.

FIG. 5 shows a schematic view of a channel in an object together with a support structure in the channel.

FIG. 6 shows another example of a channel with a support structure positioned therein.

FIG. 7 shows schematic illustrations of support structures with different contact support structure parts.

FIG. 8 shows an embodiment of a control data generating assembly.

### DETAILED DESCRIPTION OF THE EMBODIMENTS

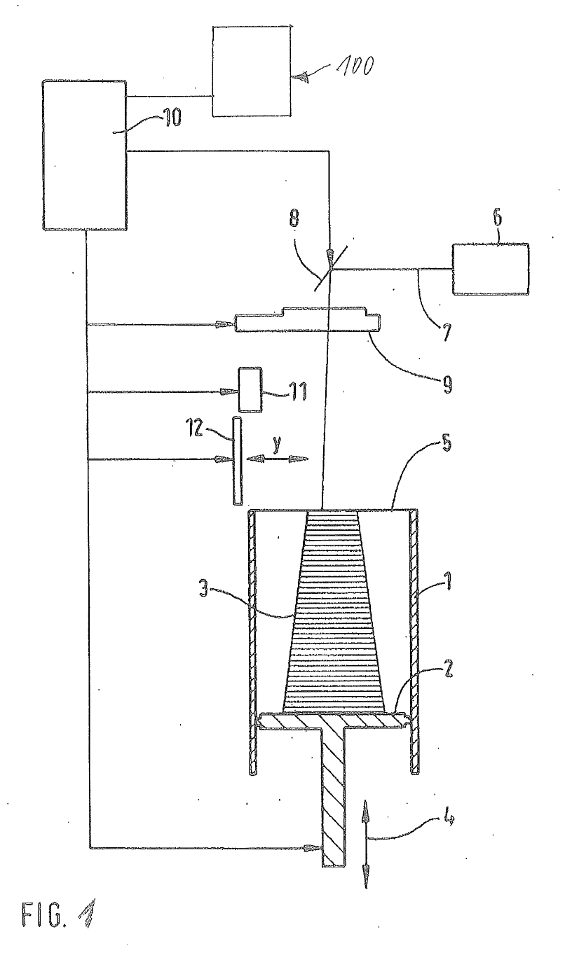

At first, for a description of an inventive method in the following a laser sintering device is described as example for an inventive additive manufacturing device by making reference to FIG. 1.

The device comprises a building container 1, in which a support 2 for carrying the object 3 to be generated is provided. By means of a height adjustment device 4, the support 2 can be moved in a vertical direction within the building container. Building material in powder form that has been applied as a layer is solidified in a building plane 5. A laser 6 that generates a laser beam 7 is provided for solidifying the material in powder form in the building plane 5. The laser beam 7 is scanned across the building plane 5 by means of a deflection device 8 and optionally a focussing device 9. A control unit 10 is provided, which control unit 10 drives the deflection device 8 and optionally the focussing device 9 such that the laser beam 7 may be directed to arbitrary positions within the building plane 5 inside of the building container 1.

The control unit 10 is operated by means of a control data set (instruction set) comprising a.o. data describing the structure of an object to be manufactured, in particular a three-dimensional computer-based model of an object defining the cross-section of the object in each respective layer of building material to be solidified. The control data set also comprises data defining the exact parameters for solidifying the building material.

A supply device 11 is provided, which supply device 11 supplies the building material in powder form for a layer to be applied. By means of an application device (recoating device) 12 building material is applied in the building plane 5 and flattened in order to have a smooth powder surface.

When the additive manufacturing device operates, the control unit 10 triggers the height adjustment device 4 to lower the support 2 layer by layer, the control unit 10 drives the application device 12 such that a new powder layer is applied in the building plane 5 and the control unit 10 drives the deflection device 8 and optionally also the laser 6 and/or the focussing device 9 such that the laser beam 7 is directed to all positions of the applied powder layer that correspond to the respective cross-section of the object to be solidified in the applied layer. In order to solidify the material, the powder grains are partially or completely melted by means of the laser beam 7, so that after having cooled down the powder grains are in a joined state forming a solid state region of the object to be generated.

All powders or powder mixtures suitable for a laser sintering or laser melting method may be used as building material in powder form. Such powders include e.g. plastic powders like polyamide or polystyerene, PEAK (Polyaryletherketone) elastomers such as PEBA (Polyether Block Amide), plastic-coated sand, ceramics powder or (which is particularly preferred) metal powder such as stainless steel powder or other metal powders adapted to a respective purpose, in particular alloys.

When building objects by means of an additive manufacturing process, often an object is built together with support structures supporting the object in order to compensate stress occurring in an object during the manufacturing process usually due to temperature differences. Usually, but not always, such support structures are removed when the additive manufacturing process has been completed. As already mentioned in the introduction, sometimes residues from the support structures remain on the surface, which residues are difficult to remove and provide an undesired resistance to the flow of a fluid adjacent to the surface. Here, according to the invention, when support structures are added, an effect of support structures or support structure residues onto the flow of a fluid adjacent the surface is taken into consideration. In particular, the invention makes use of the fact that when constructing a part that is destined to be used in a flow path of a fluid, usually simulations are made in order to study the flow of the fluid through or around said object. Such simulations can be used for determining the flow path direction at regions of an object surface, where a support structure is intended to be added during the manufacture of said object.

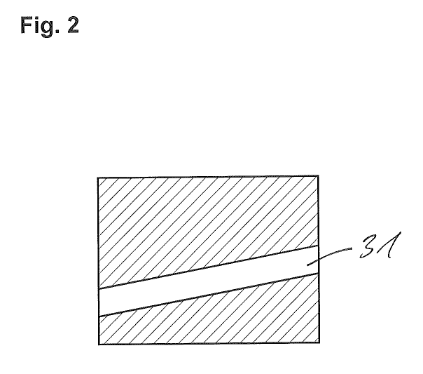

When adding support structures for a manufacture, model data describing the three-dimensional support structure are added to the three-dimensional computer-based model of the object, which means that the control data set used by the control unit 10 is modified. Here, according to the invention, a contact region between a support structure and an object surface destined to be in the flow path of a fluid is oriented such that said contact region extends essentially in parallel to the flow path adjacent said contact region after the support structure has been removed and the object is actually used in the intended way. This is illustrated by making reference to FIGS. 2 to 4.

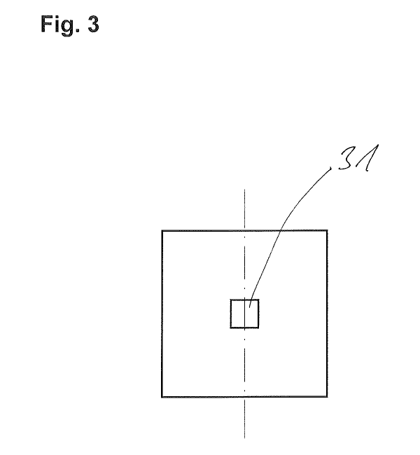

FIG. 2 shows a vertical cut through an object that has been manufactured by an additive manufacturing device, which object has a channel 31 running therethrough. The exemplary object has a cuboidal shape and FIG. 3 shows a view onto the right face of the object illustrated in FIG. 2. From FIG. 3 it is apparent that the channel 31 in this example has a quadratic cross-section. A dashed line in FIG. 3 indicates the position of the vertical cut shown in FIG. 2.

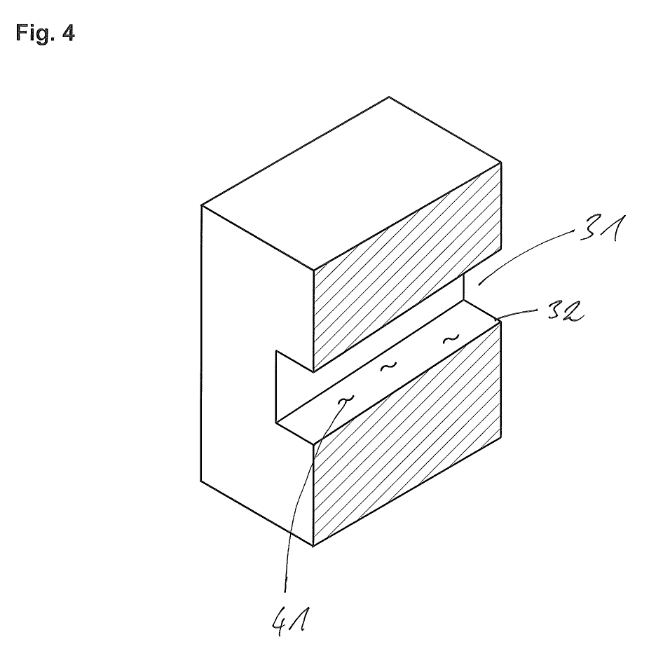

FIG. 4 shows a perspective three-dimensional view onto the plane shown in FIG. 2. Please note that the hatching in FIGS. 2 and 4 is not related to the layers during the additive manufacturing process. In FIG. 4, residues 41 of a support structure that was present in the channel 31 during the manufacturing of the object can be recognized on the bottom surface 32 of the channel 31. Whereas the support structures have already been removed from the object, in the contact regions between the support structures and the bottom surface 32 residues 41 are still there.

In accordance with the present invention, the residues and contact regions, respectively, 41 in FIG. 4 have been designed taking into consideration the direction of the flow path of a fluid through the channel 31 adjacent the surface 32 during the intended use of the object. In the specific example of FIG. 4 the fluid will not have a straight flow path close to the surface 32, but will have a curved flow path at the positions where the contact regions 41 are located. By the adapted design of the contact regions 41, the flow resistance at the positions of residues 41 is minimized.

Though FIGS. 2 to 4 show a channel through an object, the invention is not limited to channels through objects but is also applicable to outer surfaces of objects, in particular recesses. According to the invention, after a skilled person has decided at which positions a support structure will make contact to an object, the contact regions at that positions are defined in the inventive way. Here, the orientation of the contact regions with respect to the flow path will define the flow resistance of the residues. In case the contact regions have a longitudinal shape with the longest extension (largest dimension) in the direction of the flow path and a very small dimension perpendicular to the direction of the flow path, the flow resistance will be particularly small.

It shall be mentioned here that the size of the residues of the support structure in the contact regions may depend on a polishing process that is used for removing the residues. Nevertheless, irrespective of the kind of polishing process applied, the invention will lead to favourably small flow resistances for a given polishing method by the specific design of the contact regions between one or more support structures and the object surface.

When there is not only one but there are several contact regions between one or more support structures and an object surface, also the location of the individual contact regions with respect to one another will have an influence on the flow resistance when it is assumed that in each contact region a support structure residue is left and the object is used in a flow path of a fluid. This was realized by the inventors and therefore the inventors suggest arranging the contact regions of a support structure such that a direction of arrangement is in parallel to the flow path of the fluid, meaning e.g. that the arrangement of the contact regions is along a fluid layer for a laminar flow.

While the inventive choice of the orientation and shape of the contact regions of one or more support structures leads in any case to an improvement, there may be also a situation, in which the whole support structures are left at the object, for example in a case, in which it is impossible to remove such support structures. In particular for such a situation, the inventors suggest orienting the whole support structures in parallel to the flow path of the fluid around or through the object. In order to do so, a support structure has to be designed such that it has a longitudinal shape extending in the direction of the flow path at those portions of the surface adjacent to which a fluid will be flowing when using the object.

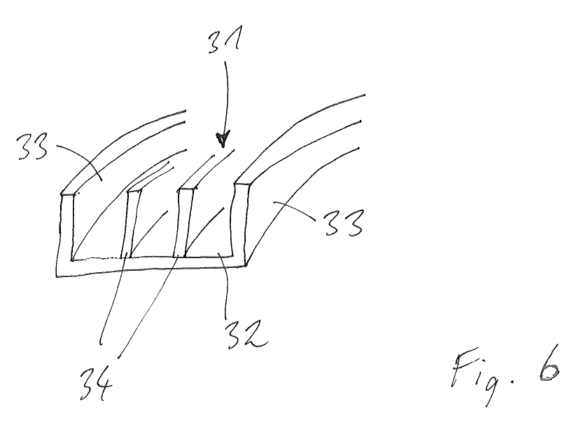

FIG. 6 shows an example for such a situation. In FIG. 6 a channel 31 is illustrated, which channel 31 belongs to an object to be manufactured by additive manufacturing. Such channel 31 has a bottom surface 32 and two sidewalls 33. As can be seen in FIG. 6, a support structure consists of two walls 34 running essentially in parallel to the sidewalls 33. In the example of FIG. 6 it is assumed that a fluid will flow through the channel 31 in a flow direction always in parallel to the sidewalls 33. Accordingly, the two walls 34 of the support structure extend in the flow direction in parallel to the sidewalls 33.

While during the manufacture of an object by additive manufacturing usually support structures provide support from below, according to the invention one can also have horizontally extending support structures, which may be advantageous due to the following consideration:

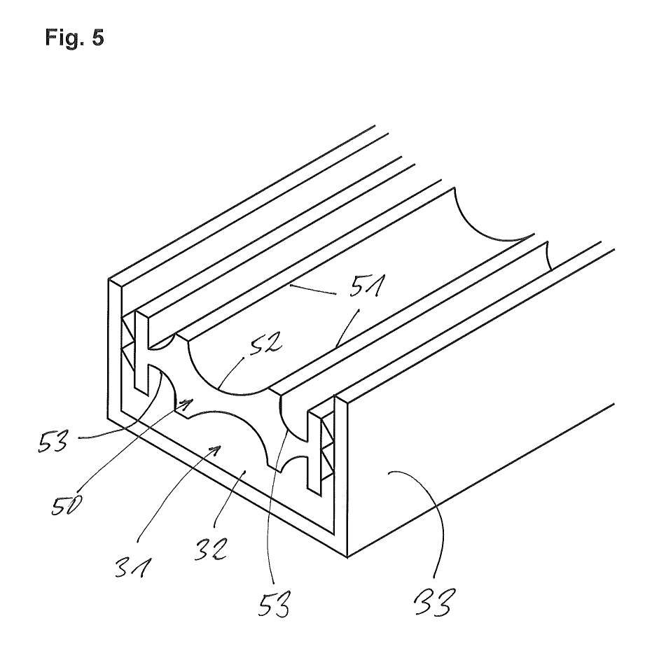

During the process of manufacturing an object by a layer-wise additive manufacturing method new layers of unsolidified powder are applied onto already solidified parts of the object (see FIG. 1). Here, fragile portions of an object may be in danger of being broken during the application of a new powder layer due to horizontal forces transferred from the application device onto those fragile portions. Thus, a support structure providing support in a horizontal direction will prevent such damages. A horizontal extension of a support structure can be implemented by connecting the support structure laterally to a side surface of the object to be produced. This is illustrated in FIG. 5.

FIG. 5 shows a channel 31, which is assumed to be a portion of an object to be produced. A support structure 50 is connected to the sidewalls 33 of such channel 31 thereby providing a lateral support to the sidewalls 33. In FIG. 5 the support 50 has particular strength in a direction perpendicular to the sidewalls 33 by providing a lateral interconnection 52 with U-shaped arches between vertical plates 51. Instead of a U-shape, it is possible to have a shape of the arch like a half of a “U” as designated by reference numbers 53 in FIG. 5. Alternatively, the lateral interconnections 52 may be shaped in a different way having nevertheless their largest vertical extensions near the interfaces to the vertical portions 51.

The support structure 50 shown in FIG. 5 does not have any connections to the bottom surface 32 of the channel 31. It is also possible to have such additional connections between the support structure 50 and the bottom surface 32. However, without such connections to the bottom surface a particularly strong resistance against lateral forces can be achieved.

It is also possible to have complicated webs of lateral interconnections 52 between vertical parts 51 of a support structure. Though this is not shown, it is further possible to have two support structures 50 such as the one shown in FIG. 5 intersecting at an angle (e.g. 90°) or to have a grid, in which a support structure 50 such as the one shown in FIG. 5 forms a bar within the grid. Please note here, that the grid may also be formed out of bars having a different shape than the support structure 50 shown in FIG. 5. What is important here is that a grid is formed from laterally extending bars that have no vertical connection to the object to be formed so that a particularly strong lateral support is provided.

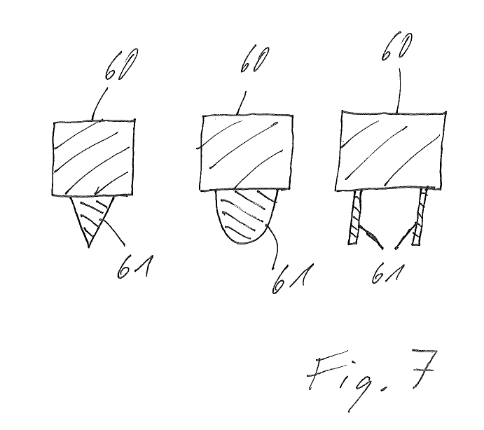

In cases in which it is intended to remove the support structure from the object after having manufactured the object, preferably there should be a preconfigured point of breakage for removing the support structure. In order to provide such a preconfigured breaking point, the support structure can be designed to have a main support structure part and a contact support structure part, the latter being located adjacent the contact region to the object to be manufactured. Here, the contact support structure part can be designed to break more easily than the main support structure part. This can be achieved for example by having an essentially V-shaped, U-shaped or Π-shaped contact support structure part. FIG. 7 shows different possible designs as examples. In FIG. 7 the main support structure part, which is shown only schematically, is designated by reference number 60 and each of the three exemplary contact support structure parts is designated by reference number 61. In addition, FIG. 5 shows an example for sawtooth-like contact support structure parts 61. Of course, the shapes of the contact support structure parts are only examples and each of the contact support structure parts 61 shown in FIG. 7 can for example be flipped upside-down. Moreover, the contact support structure parts preferably should be designed such that they extend in parallel to the flow path of the fluid.

According to the invention, control data, which are used as input by a control unit 10 in an additive manufacturing device, are generated. As already mentioned above, such control data generating method may be implemented by software or hardware alone or by a mixture of hardware and software. Accordingly, the actual device by which the control data generating method is implemented is termed here “control data generating assembly”. Such control data generating assembly needs as input a computer-based model of at least a portion of the surface of a three-dimensional object to be generated by additive manufacturing.

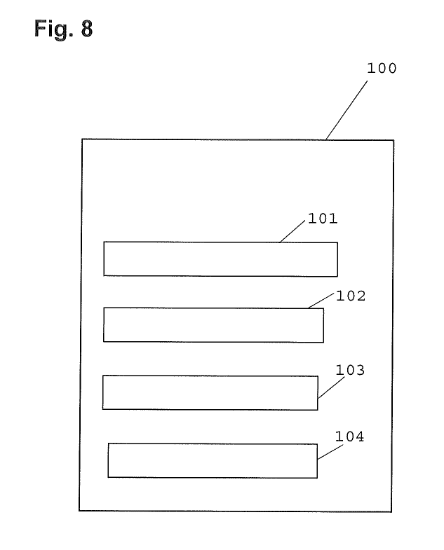

A control data generating assembly 100 is schematically illustrated in FIG. 8. It includes an identification unit 101 that identifies those surface data that correspond to at least one surface of the object that is destined to get into contact with a fluid flow. The information, which surface data are related to a surface destined to get into contact with a fluid flow either may be input by a user via a terminal or may already be included in a computer-based model of an object.

As it is necessary to determine the flow path adjacent that portion of the surface, where a support structure shall be added, either the control data generating assembly may calculate by itself for example the necessary vector fields or may receive respective data about the flow path from a different unit via an input device from a computer network or a portable data carrier. In each of both cases the corresponding part of the control data generating assembly (calculation device or input device) is termed “determination unit”. Such a determination unit 102 is thus also illustrated in FIG. 8.

In order to add the support structure data, the three-dimensional computer-based model of the object to be manufactured has to be modified such that support structure data are added to the computer-based model. Here, a modification unit 103 adds the support structure to the computer-based model in accordance with the inventive methods as described above. In particular, the support structure will be added in such a way that a contact region between the support structure and the object will essentially extend in parallel to the flow path adjacent the region of the object surface where such contact region is located. In addition or alternatively to this in case of a plurality of contact regions these contact regions are added such that their positions extend in parallel to the flow path adjacent the surface where these contact regions are located.

Finally, the modified three-dimensional model data of the object have to be integrated into the control data for a manufacture of the three-dimensional object by means of an additive manufacturing apparatus. In other words, control data are derived based on the modified three-dimensional computer-based model of the object, which is the reason why that part of the control data generating assembly by which this implemented is shown in FIG. 8 as “derivement unit” 104.

The control data generating assembly 100 either may be implemented in an additive manufacturing device (as shown in FIG. 1) or may be implemented in a separate device. In the latter case it is necessary to transfer the control data to an additive manufacturing device via a portable data carrier or a computer network (e.g., the internet).

In case the inventive control data generating method is implemented by software, it is of course also possible that such software is running on a CAD-system used for designing an object. However, usually additive manufacturing experts have a better knowledge on necessary support structures than designers of an object in front of a CAD system.

In principle, the invention can be applied to any additive manufacturing device. In particular it can be applied to devices, in which objects are built layer-wise by melting or sintering powders by means of electromagnetic radiation or particle radiation such as laser sintering devices or laser melting devices.

Finally it shall be mentioned that a further optimization of the flow resistance can be achieved by taking into consideration the direction of the fluid flow. This is implemented by designing either a support structure as a whole or at least the part of the support structure at the contact regions to the object such that a flow resistance is smaller in the direction of a fluid flow than in a direction differing from the flow direction, such as a direction opposite to the flow direction. Also, the invention may be applied to the manufacturing of not only one object in a build run but to the manufacturing of several objects in parallel in the same build run. Here, surface data of objects that will get into contact with a fluid flow may all be treated in accordance with the invention when adding support structures.

1. A method of generating control data for a manufacture of a three-dimensional object by means of a layer-wise solidification of a building material, wherein said manufactured three-dimensional object is destined to be used in a flow path of a fluid flowing in a designated way around or through said object, said method comprising the following steps:
identifying surface data in a three-dimensional computer-based model of said three-dimensional object, said surface data corresponding to at least one surface of the manufactured three-dimensional object, which at least one surface is destined to get into contact with the fluid,
determining the flow path adjacent a portion of said at least one surface in said computer-based model
modifying said three-dimensional computer-based model thus generating a modified computer-based model such that support structure data are added to the computer-based model, said support structure data specifying a support structure designed to be in contact with said portion of said at least one surface during the manufacture of said three-dimensional object,
wherein said support structure data are added to the computer-based model such that at least one contact region between the support structure and said portion of said at least one surface will essentially extend in parallel to the flow path adjacent said portion of said at least one surface and/or such that positions of a plurality of contact regions between a plurality of support structures and said portion of said at least one surface will essentially extend in parallel to the flow path adjacent said portion of said at least one surface
deriving control data for the manufacture of the three-dimensional object from the modified computer-based model.

2. The method according to claim 1, wherein said support structure data define a support structure that has a longitudinal shape such that in a direction in parallel to the flow path it is longer than in any other direction not in parallel to the flow path.

3. The method according to claim 1, wherein said at least one surface is located in a channel through said three-dimensional object.

4. The method according to claim 3, wherein said support structure data are added in such a way to the computer-based model that, when a vertical direction is defined as a direction perpendicular to the plane in which the layers extend during the layer-wise manufacturing, at least a portion of said contact region is located at a lateral wall of said channel.

5. The method according to claim 1, wherein said support structure data are added in such a way to the computer-based model that once the three-dimensional object has been manufactured in said contact region said support structure will provide a flow resistance that is smaller in the designated flow direction than in a direction angular thereto.

6. The method according to claim 5,
wherein said support structure data are added in such a way to the computer-based model that once the three-dimensional object has been manufactured said support structure will provide a flow resistance that is smaller in the designated flow direction than in a direction angular thereto.

7. The method according to claim 1, wherein said support structure data define said support structure to comprise a main support structure part and a contact support structure part, said contact support structure part being located adjacent said portion of said at least one surface, wherein said contact support structure part is essentially V-shaped, U-shaped or Π-shaped in a cross-section perpendicular to said flow path.

8. The method according to claim 1, wherein said support structure data are added in such a way to the computer-based model that, when a vertical direction is defined as a direction perpendicular to the plane in which the layers extend during the layer-wise manufacturing, said support structure once manufactured consists of a multitude of essentially vertical portions, at least two of which are interconnected laterally by at least one interconnection structure.

9. The method according to claim 8, wherein in the support structure once manufactured said at least one interconnection structure does not reach vertically to said portion of said at least one surface.

10. The method according to claim 8, wherein in the support structure once manufactured said at least one interconnection has its largest vertical extensions at or near the interfaces to the vertical portions that are interconnected.

11. The method according to claim 8, wherein in the support structure once manufactured said at least one interconnection has an essentially H-shaped or U-shaped cross-section in a plane perpendicular to said vertical portions.

12. A method of manufacturing a three-dimensional object by means of a layer-wise solidification of a building material, wherein said manufactured three-dimensional object is destined to be used in the flow path of a fluid flowing in a designated way around or through said object, said method comprising the following steps:
generating control data for a manufacture of a three-dimensional object by means of a layer-wise solidification of a building material by using a method according to claim 1,
manufacturing said three-dimensional object on the basis of the control data by means of a layer-wise solidification of a building material,
removing the support structure after the manufacturing step.

13. A control data generating assembly for generating control data for a manufacture of a three-dimensional object by means of a layer-wise solidification of a building material, wherein said manufactured three-dimensional object is destined to be used in a flow path of a fluid flowing in a designated way around or through said object, said control data generating assembly comprising the following:
an identification unit engineered to identify surface data in a three-dimensional computer-based model of said three-dimensional object, said surface data corresponding to at least one surface of the manufactured three-dimensional object, which at least one surface is destined to get into contact with the fluid,
a determination unit for determining the flow path adjacent a portion of said at least one surface
a modification unit which in operation modifies said three-dimensional computer-based model thus generating a modified computer-based model such that support structure data are added to the computer-based model, said support structure data specifying a support structure designed to be in contact with said portion of said at least one surface during the manufacture of said three-dimensional object,
wherein said support structure data are added to the computer-based model such that at least one contact region between the support structure and said portion of said at least one surface will essentially extend in parallel to the flow path adjacent said portion of said at least one surface and/or such that positions of a plurality of contact regions between a plurality of support structures and said portion of said at least one surface will essentially extend in parallel to the flow path adjacent said portion of said at least one surface,
a derivement unit which in operation derives control data for the manufacture of the three-dimensional object from the modified computer-based model.

14. An apparatus for the manufacture of a three-dimensional object by means of a layer-wise solidification of a building material, wherein said manufactured three-dimensional object is destined to be used in the flow path of a fluid flowing in a designated way around or through said object, the apparatus comprising
a control data generating assembly according to claim 13 and/or a data interface thereto.

15. A computer program comprising a sequence of instructions that enables a control data generating assembly to carry out a method according to claim 1, when such sequence of instructions is carried out by the control data generating assembly.

16. A computer program comprising a sequence of instructions that enables an apparatus for the manufacture of a three-dimensional object to carry out a method according to claim 12, when such sequence of instructions is carried out by the apparatus.
